(19) United States
(12) Patent Application Publication
(10) Pub. No.: US 2010/0014301 A1
(43) Pub. Date: Jan. 21, 2010

(54) Bracketless Snap-In Fog Lamp

(76) Inventor: Peter G. Demarois, Troy, MI (US)

Correspondence Address: MAGNA INTERNATIONAL, INC., 337 MAGNA DRIVE, AURORA, ON, L4G-7K1, CA

(21) Appl. No.: 12/160,054

(22) PCT Filed: Dec. 4, 2006
(86) PCT No.: PCT/CA06/01960

§ 371 Date: Oct. 23, 2008

Related U.S. Application Data
(60) Provisional application No. 60/756,872, filed on Jan. 6, 2006.

(51) Int. Cl. F21V 21/14; F21V 21/00

(52) U.S. Cl. 362/418; 362/382

(57) ABSTRACT

A lamp assembly providing a lamp, a secondary component, an attachment device, and an adjustment mechanism. The attachment device connects to the secondary component. The adjustment mechanism controls the position of the lamp prior to and after the attachment device is connected to the secondary component.

### CROSS-REFERENCE TO RELATED APPLICATIONS

This application claims the benefit of U.S. Provisional Application No. 60/756,872, filed Jan. 6, 2006.

### FIELD OF THE INVENTION

The present invention relates to a bracketless fog lamp assembly.

### BACKGROUND OF THE INVENTION

Most motorized vehicles today have headlights so that the vehicle can be used during non-daylight hours. In addition, vehicles can have fog lamps which are placed below the vehicle's headlights in order to provide additional light from a lower height during adverse conditions such as foggy weather. By placing the fog lights below the headlights, the light emitted from the fog light has less reflection off of the fog, which reduces the amount of light being reflected back to the vehicle, which ultimately can interfere with the vehicle's driver's field of vision. The fog lamps are usually smaller than the vehicle's headlights, and are a part of the lower front end component of the vehicle, such as a fascia.

However, attaching the fog lamps to the fascia can be a timely and a costly manufacturing process. For example, the fog lamps need to be properly secured to the fascia in order to prevent the fog lamps from moving at undesirable times. One way of securing the fog lamp to the fascia is by using a specialized bracket system which is connected to the fog lamp and is mounted to the fascia by extending screws through the bracket into the fascia. By using a bracket system such as this, the cost of the manufacturing process is increased due to the time it takes to mount and secure the bracket to the fascia. Furthermore, the material which is dependent upon the size of the bracket increases the cost of manufacturing and shipping the fog lamp. For example, the bracket takes up space in the shipping container so that a lower number of fog lamps can be shipped in the same container. In addition, the bracket system adds weight to the fog lamp assembly, which increases shipping cost. Thus, the cost of shipping is increased since a lower of number of fog lamps can be shipped in the same container, and due to the additional weight added to the fog lamp assembly by the bracket system.

When the fog lamp is mounted to the fascia by a bracket system, the fog lamps can be but not always be pre-adjusted prior to being attached to the fascia. Typically, after the fog lamp is mounted to the fascia, the assembler of the vehicle has to adjust the fog lamp so that it is directed in the proper direction. This additional manufacturing step adds time and cost to the assembling of the vehicle, specifically to the manufacturer of the vehicle.

Therefore, it is desirable to develop a fog lamp assembly in which the fog lamp is mounted to the vehicle without using brackets or screws. Further, it would be desirable to develop a fog lamp assembly in which the lamp can be pre-adjusted prior to being attached to the vehicle, such that the lamp will be positioned in the desired direction prior to assembly.

### SUMMARY OF THE INVENTION

The present invention relates to a lamp assembly providing a lamp, an attachment device, and an adjustment mechanism. The attachment device connects to the secondary component. The adjustment mechanism controls the position of the lamp prior to and after the attachment device is connected to the secondary component.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings wherein like numerals represent like elements, and wherein:

FIG. 1 is a perspective view of the fog lamp assembly prior to being connected to a secondary component in accordance with an embodiment of the present invention;

FIG. 2 is a rear perspective view of the fog lamp assembly connected to the secondary component in accordance with an embodiment of the present invention; and

FIG. 3 is a rear perspective view of the fog lamp assembly with portions of an adjustment mechanism removed in accordance with an embodiment of the present invention.

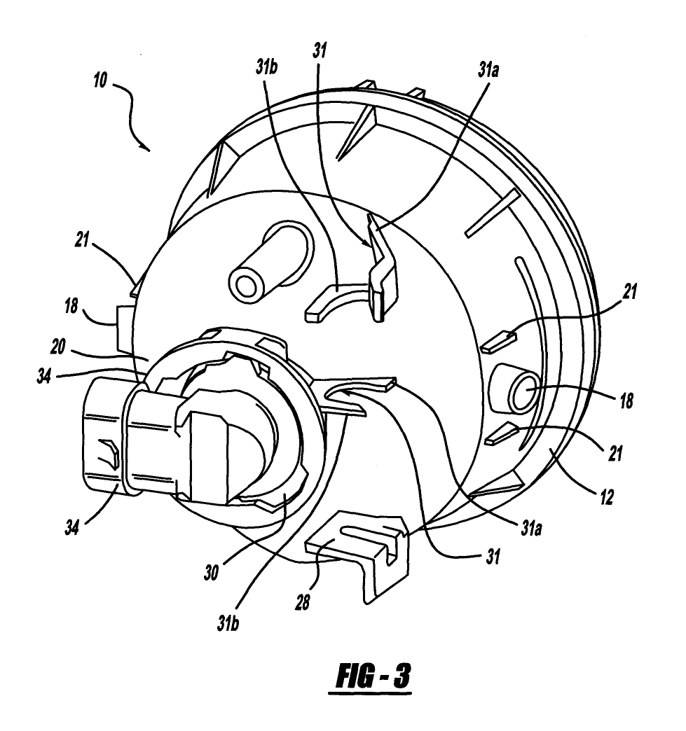

### DETAILED DESCRIPTION OF THE PREFERRED EMBODIMENTS

The following description of the preferred embodiment(s) is merely exemplary in nature and is in no way intended to limit the invention, its application, or uses.

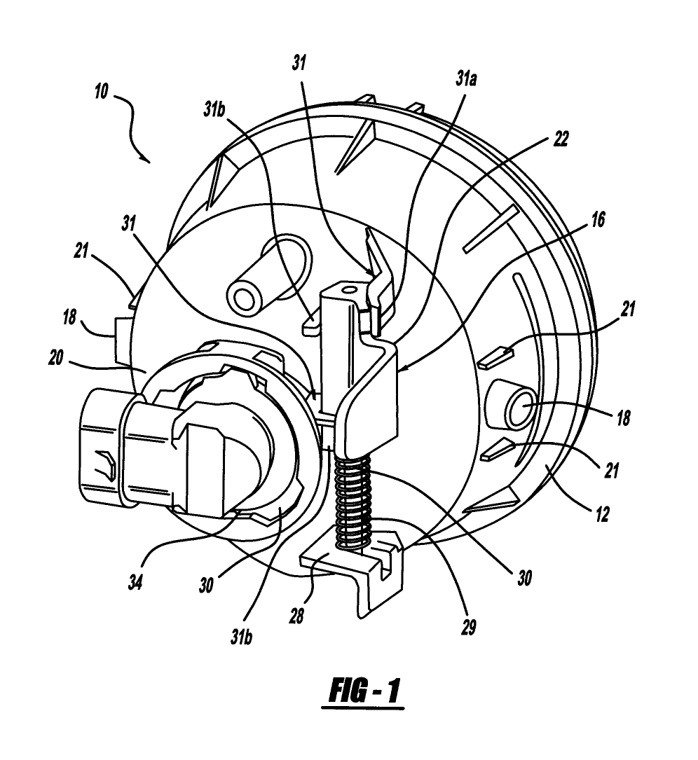

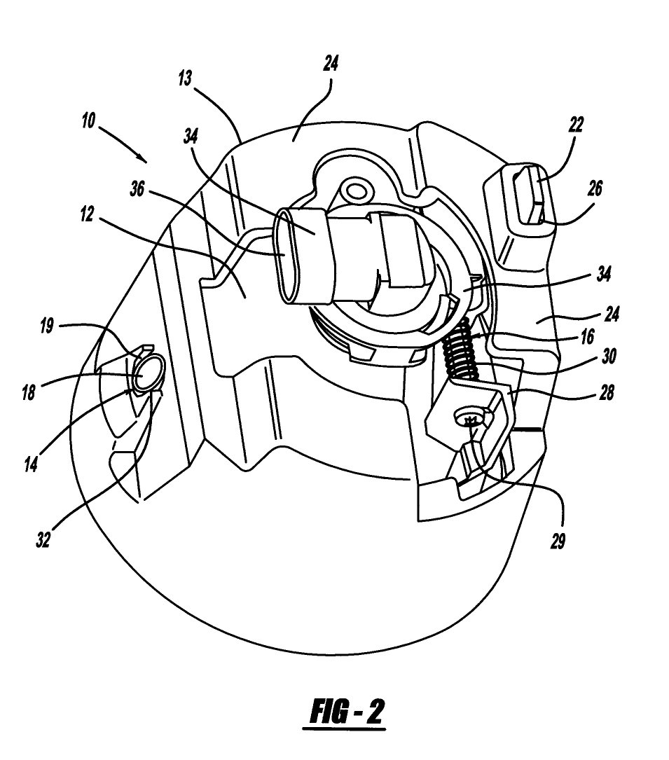

Referring to FIGS. 1 and 2, a fog lamp assembly is generally shown at 10. The fog lamp assembly 10 has a lamp 12 that is connected to a secondary component 13. Typically, the secondary component 13 is a component on a motorized vehicle, such as but not limited to, a fascia, which extends along the front end (not shown) of a vehicle (not shown) below the headlights (not shown) of the vehicle. An attachment device, generally indicated at 14, is used to mechanically lock the lamp 12 to the secondary component 13. In addition, the fog lamp assembly 10 has an adjustment mechanism, generally indicated at 16, which is used to control the position of the lamp 12 prior to and after the attachment device 14 mechanically locks the lamp 12 to the secondary component 13.

The attachment device 14 has at least one arm 18 that extends from the lamp 12. The arm 18 is accepted by a receiver 19 in the secondary component 13. The lamp 12 can have two arms 18 which are accepted by two receivers 19 in the secondary component 13. The predetermined size and number of arms 18 varies depending on several factors, such as but not limited to, size of the lamp 12 and the strength of the vehicle component 13 material. Thus, the predetermined size and number of arms 18 and corresponding receivers 19 must be adequate to support and mechanically lock the lamp 12 to the secondary component 13, while the lamp 12 remains capable of pivoting after being attached to the secondary component 13.

The arm 18 extends from a side portion of the lamp 12, such that the arm 18 is not visible from the exterior side of the lamp 12. The exterior side of the lamp 12 is the side of the lamp 12 that extends through the secondary component 13 and is visible on the exterior of the vehicle. When the arm 18 is accepted by the receiver 19, the arm 18 and receiver 19 mechanically lock the lamp 12 to the secondary component 13. The end of the arm 18 can be angled such that the shorter side of the arm 18 will slide into the receiver 19 when the lamp 12 is being inserted into the secondary component 13. Thus, once the arm 18 has been accepted by the receiver 19, the larger side of the arm 18 will prevent the arm 18 from being removed or separated from the receiver 19 and the secondary component 13.

Additionally, the lamp 12 has at least one rib 21 that extends along the lamp 12 adjacent to the arm 18. Thus, after the arm 18 has been accepted by the receiver 19, the rib 21 contacts the secondary component 13 which creates friction between the lamp 12 and the secondary component 13. This friction prevents the lamp 12 from undesirably moving with respect to the secondary component 13 at undesirable times. The lamp 12 can have two ribs 21 which extend parallel to one another on opposite sides of the arm 18. Thus, friction is being created by the two ribs 21 at equal distances around the arm 18. It should be appreciated that while two ribs 21 are described, any number of ribs can be used depending on a particular application.

Further, the combination of the arm 18 accepted by the receiver 19 creates a pivot point 32. Thus, as the arm 18 is operably connected to the secondary component 13 the lamp 12 changes positions with respect to the secondary component 13. The arm 18 can be a cylindrical arm that extends from the side of the lamp 12 which is accepted by the receiver 19, such that the arm 18 rotates inside the receiver 19 to create the pivot point 32. The receiver 19 has a diameter that is slightly larger than the diameter of the arm 18, so that the arm 18 is accepted by the receiver 19 and the arm 18 rotates within the receiver 19.

The attachment device 14 does not include any brackets or screws, such that the leg 18 and the receiver create an adequate connection so that the lamp 12 is sufficiently connected to the secondary component 13 and the lamp 12 will not move at undesirable times. By not using brackets and screws, the fog lamp assembly 10 is a more compact assembly than an assembly used to attach a lamp to a secondary component that uses brackets and screws. This is beneficial when shipping the fog lamp assembly 10 or multiple fog lamp assemblies 10 because a bracket that is used to secure the lamp to a secondary component extends out from the fog lamp assembly and occupies additional area in the shipping packaging which reduces the number of assemblies that can be shipped in a single unit.

In addition, the attachment of a bracket by screws in order to secure lamp to the secondary component requires additional time and cost when compared to securing the lamp 12 to the secondary component 13 by the attachment device 14. The assembly time increases because the assembler must align the lamp and secondary component so that the screws can connect the lamp to the bracket. The cost of the assembly increases because the brackets and screws required for connecting and adjusting the lamp to the secondary component are additional material and parts, which are not all needed in the lamp assembly 10.

The adjustment mechanism 16 provides of a tab 22 that extends through the secondary component 13 so that the tab 22 is accessible from a rear side 24 of the secondary component 13. The tab 22 can extend outward from a rear portion 20, and the secondary component 13 has an opening 26 defined by the rear portion 20. The tab 22 extends through the opening 26 in order to maintain the angle of the lamp 12 with respect to the secondary component 13. Also, the adjustment mechanism 16 has a base 28 that extends from the rear portion 20. At least one screw 29 and at least one spring 30 are attached to and extend between the tab 22 and the base 28. Thus, the screw 29 maintains the desired distance between the tab 22 and the base 28, and the spring 30 maintains the desired distance between the tab 22 and the base 28 under tension.

At least one holder, generally indicated at 31, extends from the rear portion 20 in order to hold or support the tab 22. Two holders 31 can extend from the rear portion 20, and the holders 31 have a fork or “Y” shape so that a first prong 31a and a second prong 31b extend across the diameter of the tab 22 on opposite sides of the tab 22 from one another. Therefore, the tab 22 remains in the same position with respect to the holders 31 when the tab 22 is being altered to adjust the lamp 12 with respect to the secondary component 13.

As the tab 22 is moved, the screw 29 moves into or out of the tab 22, depending on the desired distance between the tab 22 and the base 28. The tab 22 can have a hollow interior (not shown) and the interior walls can be threaded so that the tab 22 accepts the threaded screw 29. By way of explanation and not limitation, when the screw 29 moves farther into the tab 22 the distance between the tab 22 and the base 28 is reduced and the lamp 12 is directed down. Thus, the direction of the screw 29 movement is the opposite of the direction of the lamp 12 movement with respect to the secondary component 13. The spring 30 maintains the distance between the tab 22 and screw 29 under tension by being coiled to apply a force on the tab 22 and base 28.

The fog lamp assembly 10 has a socket 34 which is used to secure a light bulb (not shown) in the lamp 12. Further, wires (not shown) can extend through an axial bore 36 so that the lamp 12 is electrically connected to a vehicle's electrical system (not shown). The socket 34 can be any shape or size so long as the socket 34 does not obstruct the attachment device 14, the adjustment mechanism 16, or prevent the fog lamp assembly 10 from being inserted into the secondary component 13. It should be appreciated that the axial bore 36 can be used for any desired component to extend through.

The lamp 12 can be inserted into the secondary component 13 through the front or exterior side of the secondary component 13. The adjustment mechanism 16 can also allow for the lamp 12 to be adjusted prior to being inserted into the secondary component 13. Thus, the tab 22 is actuated so that the screw 29 moves into or out of the hollow interior of the tab 22. The spring 30 maintains the tension between the tab 22 and the base 28 so that the lamp 12 does not change positions after it is adjusted. Therefore, the manufacturer of the fog lamp assembly 10 can pre-position the lamp 12 so that the lamp 12 does not have to be positioned after the fog lamp assembly 10 is connected to the secondary component 13, most likely at a different manufacturing facility.

Additionally, the tab 22 can be used to make further adjustments to the lamp 12 with respect to the secondary component 13 after the fog lamp assembly 10 has been connected to the secondary component 13. By way of explanation and not limitation, after the lamp 12 is attached to the secondary component 13, the tab 22 maintains the angle of the lamp 12 with respect to the secondary component after the lamp 12 rotates about the pivot point 32 to the desired position. Thus, the light emitted by the lamp 12 is directed in the desired direction. This results in the position of the screw 29 being altered, and the spring 30 maintaining the distance between the tab 22 and base 28 under tension.

Typically, most of the adjustments to the direction of the lamp 12 can be made prior to the lamp 12 being connected to the secondary component 13. Thus, the lamp 12 can be adjusted by the assembler of the lamp 12 rather than the assembler of the vehicle. Also, it can be more difficult to access and adjust the lamp 12 after the lamp 12 is connected to the secondary component 13. This is especially true when brackets and screws are used to connect the lamp to the secondary component because the adjustment brackets and screws must be loosened, adjusted and realigned, and tightened after the lamp has been connected to the secondary component. Therefore, the fog lamp assembly 10 allows for the lamp 12 to be adjusted prior to being attached to the secondary component 13, and more easily after the lamp 12 is attached to the secondary component 13 when compared to a lamp assembly using brackets to connect the lamp to the secondary component.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A lamp assembly comprising:
a lamp;
a secondary component;
an attachment device, wherein said attachment device connects said lamp to said secondary component; and
an adjustment mechanism, wherein said adjustment mechanism controls the position of said lamp prior to and after said attachment device is connected to said secondary component.

2. The lamp assembly of claim 1, wherein said attachment device has at least one arm that extends from said lamp that is accepted by a receiver in said secondary component.

3. The lamp assembly of claim 2, wherein said arm inserted into said receiver acts as a pivot point in which said lamp rotates with respect to said secondary component when said adjustment mechanism is actuated.

4. The lamp assembly of claim 2, wherein said lamp has at least one rib adjacent to said arm.

5. The lamp assembly of claim 1, wherein said adjustment mechanism has a tab that extends through said secondary component so that said tab maintains an angle of said lamp with respect to said secondary component.

6. The lamp assembly of claim 5, wherein said adjustment mechanism further comprises at least one screw and at least one spring operably connected to said tab, and said screw is actuated in order to change the position of said lamp with respect to said secondary component and said spring maintains a tension between said lamp and said secondary component.

7. The lamp assembly of claim 6, wherein said adjustment mechanism has a base that is connected to said tab by said screw and said spring.

8. The lamp assembly of claim 1, wherein said secondary component is a fascia.

9. A lamp assembly comprising:
a lamp;
a secondary component; and
an attachment device that connects said lamp to said secondary component, wherein said attachment device has at least one arm that extends from said lamp and said arm is accepted by said secondary component in order for said arm to connect to said secondary component.

10. The lamp assembly of claim 9, wherein a receiver on said secondary component accepts said arm.

11. The lamp assembly of claim 9, wherein said arm inserted into said secondary component acts as a pivot point in which said lamp rotates with respect to said secondary component.

12. The lamp assembly of claim 9, wherein said lamp has at least one rib adjacent to said arm.

13. The lamp assembly of claim 9 further comprising an adjustment mechanism that controls the position of said lamp prior to and after said attachment device is connected to said secondary component.

14. The lamp assembly of claim 13, wherein said adjustment mechanism has a tab that extends from said lamp through said secondary component so that said tab maintains an angle of said lamp with respect to said secondary component.

15. The lamp assembly of claim 9, wherein said secondary component is a fascia.

16. A lamp assembly comprising:
a lamp;
a secondary component, wherein said lamp is connected to said secondary component; and
an adjustment mechanism that controls the position of said lamp prior to and after said lamp is connected to said secondary component, wherein said adjustment mechanism has a tab that extends from said lamp through said secondary component so that said tab maintains an angle of said lamp with respect to said secondary component.

17. The lamp assembly of claim 16, wherein said adjustment mechanism has a base that is connected to said tab by at least one screw and at least one spring, and said at least one spring maintains the distance between said tab and said base under tension, and said at least one screw actuates into and out of said tab to alter the distance between said tab and said base.

18. The lamp assembly of claim 16 further comprising an attachment device that has at least one arm that extends from said lamp that is accepted by a receiver in said secondary component.

19. The lamp assembly of claim 18 further comprising at least one rib that is adjacent to said arm.

20. The lamp assembly of claim 18, wherein said arm inserted into said receiver acts as a pivot point in which said lamp rotates with respect to said secondary component.
